(19) United States
(12) Patent Application Publication
(10) Pub. No.: US 2013/0162962 A1
(43) Pub. Date: Jun. 27, 2013

(54) ELECTRONIC DEVICE

(71) Applicants: PO-CHING CHIANG, Tu-Cheng (TW); LUN-FENG LIAO, Tu-Cheng (TW)

(72) Inventors: PO-CHING CHIANG, Tu-Cheng (TW); LUN-FENG LIAO, Tu-Cheng (TW)

(73) Assignee: HON HAI PRECISION INDUSTRY CO., LTD., Tu-Cheng (TW)

(21) Appl. No.: 13/567,137

(22) Filed: Aug. 6, 2012

(30) Foreign Application Priority Data
Dec. 21, 2011 (TW) 100147862

(51) Int. Cl. G03B 21/20

(52) U.S. Cl. 353/119

(57) ABSTRACT

An electronic device includes a base, a cover, and a projection apparatus. The cover is pivotably mounted on the base and defines a through hole. The projection apparatus is secured to the base and corresponds to the through hole. The projection apparatus emits light, and the light is projected out of the cover through the through hole.

### BACKGROUND

1. Technical Field

The present disclosure relates to electronic devices, and particularly a portable electronic device.

2. Description of Related Art

Portable electronic devices, such as computer notebooks and netbooks, can be convenient for presenting ideas in meetings. The electronic devices should be connected to a projector, and display pictures to a large screen through the projector. However, when there is not a projector or the projector is damaged, the electronic devices cannot display pictures to the large screen. Therefore, an improved electronic device may be desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an assembled, isometric view of the electronic device of FIG. 1.

FIG. 3 is another assembled, isometric view of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

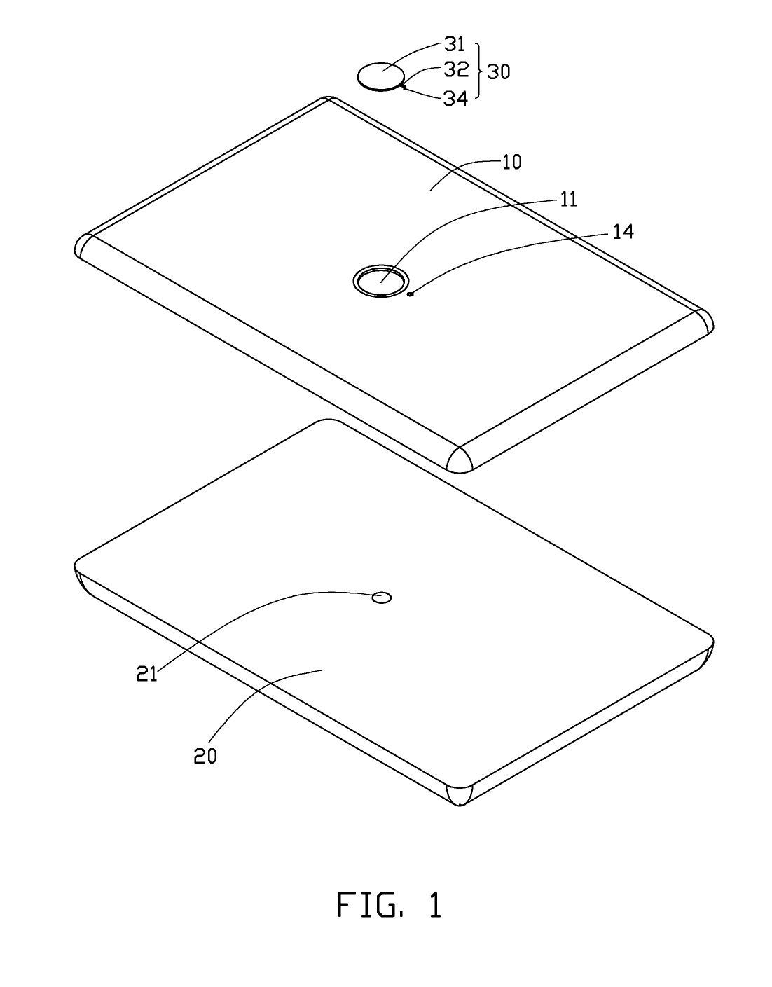

FIG. 1 shows an electronic device in accordance with an embodiment. The electronic device includes a cover 10, a base 20, and a blocking member 30. In one embodiment, the electronic device is a notebook.

The cover 10 is pivotably mounted on a side of the base 20. The cover 10 defines a through hole 11 a pivoting hole 14 adjacent to the through hole 11. In one embodiment, the through hole 11 is circular.

The electronic device further includes a projection apparatus 21 secured to the base 20. The projection apparatus 21 corresponds to the through hole 11. When the cover 10 is pivoted to cover the base 20, the projection apparatus 21 is aligned with the through hole 11, and light emitted from the projection apparatus 21 can be projected through the through hole 11.

The blocking member 30 includes a covering portion 31, a connection portion 32, and a pivoting shaft 34. In one embodiment, the covering portion 31 is circular, and a size of the covering portion 31 is equal to a size of the through hole 11. The connection portion 32 connects the covering portion 31 to the pivoting shaft 34. The pivoting shaft 34 is pivotably engaged in the pivoting hole 14. A length of the connection portion 32 is substantially equal to a smallest distance between an edge of the through hole 11 and the pivoting hole 14.

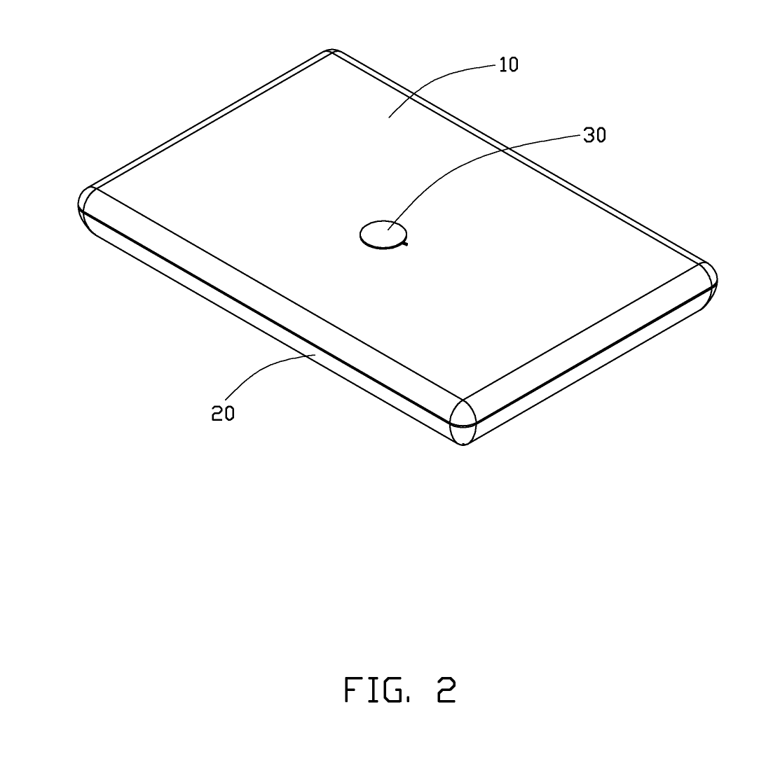

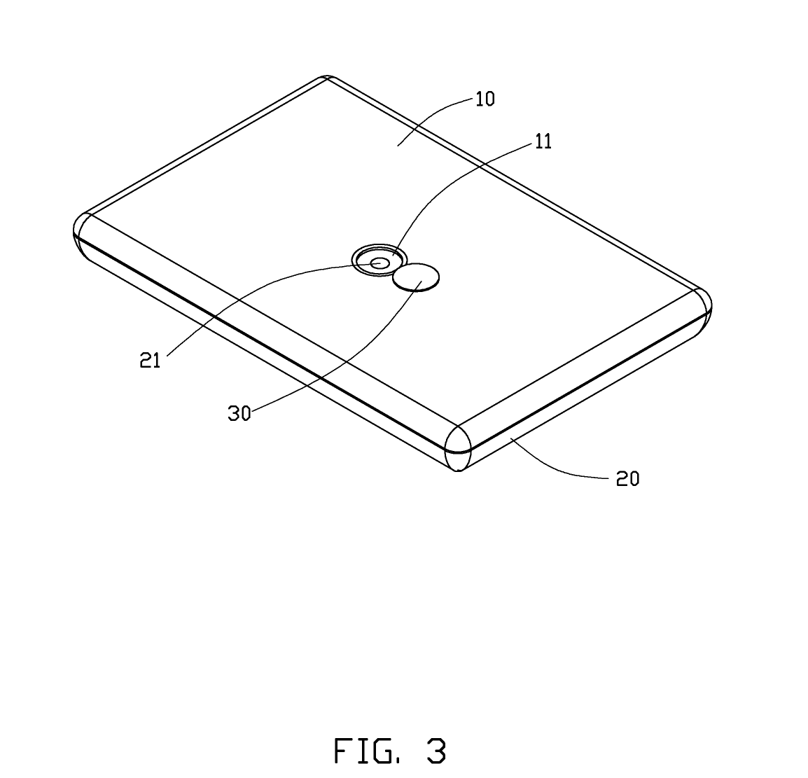

Referring to FIGS. 1-3, in assembly, the cover 10 is pivotably mounted on the base 20. The through hole 11 is aligned with the projection apparatus 21. The pivoting shaft 34 is pivotably engaged in the pivoting hole 14. Thus, the blocking member 30 is pivotable relative to the cover 10, and the covering portion 31 is pivotable to cover or open the through hole 11.

In use, the blocking member 30 is rotated to open the through hole 11. Light emitted from the projection apparatus 21 is projected on a great screen (not shown) through the through hole 11.

When the projection apparatus 21 is not used, the blocking member 30 is rotated to cover the through hole 11. Thus, the covering portion 31 blocks light projected from the through hole 11 and prevents dust from flowing into the electronic device.

In another embodiment, the covering portion 31 includes a plurality of designs, such as a trademark. When the covering portion 31 covers the through hole 11, the covering portion 31 displays the plurality of designs and makes the cover 10 more beautiful.

It is to be understood, however, that even though numerous characteristics and advantages have been set forth in the foregoing description of embodiments, together with details of the structures and functions of the embodiments, the disclosure is illustrative only and changes ay be made in detail, especially in the matters of shape, size, and arrangement of parts within the principles of the disclosure, to the full extent indicated by the broad general meaning of the terms in which the appended claims are expressed.

What is claimed is:

1. An electronic device comprising:
a base;
a cover pivotably mounted on the base and defining a through hole; and
a projection apparatus secured to the base and positioned relative to the through hole so that light beams emitted out of the projection apparatus are projected out of the cover through the through hole.

2. The electronic device of claim 1, further comprising a blocking member pivotably attached to the cover, and the blocking member is configured to pivotably cover the through hole.

3. The electronic device of claim 2, wherein the cover further defines a pivoting hole adjacent to the through hole, the blocking member comprises a pivoting shaft, and the pivoting shaft is pivotably engaged in the pivoting hole.

4. The electronic device of claim 3, wherein the blocking member further comprises a connection portion and a covering portion; the connection portion is connected between the pivoting shaft and the covering portion; and a size of the covering portion is substantially equal to a size of the through hole.

5. The electronic device of claim 4, wherein the covering portion defines a plurality of designs, when the covering portion covers the through hole, the projection apparatus is adapted to display the plurality of designs.

6. The electronic device of claim 1, wherein the through hole is circular.

7. The electronic device of claim 1, wherein the electronic device is a note book.

8. An electronic device comprising:
a base;
a cover pivotably mounted on the base and defining a through hole;
a blocking member pivotably mounted on the cover and comprising a covering portion, and the covering portion comprising a plurality of designs; and
a projection apparatus secured to the base and capable of emitting light;
wherein the blocking member is rotatable relative to the cover to rotate the covering portion to cover or open the through hole; when the covering portion opens the through hole, the light is projected out of the cover through the through hole; when the covering portion covers the through hole, the plurality of designs are displayed.

9. The electronic device of claim 8, wherein the cover further defines a pivoting hole adjacent to the through hole, the blocking member further comprises a pivoting shaft, and the pivoting shaft is pivotably engaged in the pivoting hole.

10. The electronic device of claim 9, wherein the blocking member further comprises a connection portion; the connection portion is connected between the pivoting shaft and the covering portion; and a size of the covering portion is substantially equal to a size of the through hole.

11. The electronic device of claim 9, wherein the through hole is circular.

12. The electronic device of claim 9, wherein the electronic device is a note book.
